(19) United States
(12) Patent Application Publication
(10) Pub. No.: US 2026/0368299 A1
(43) Pub. Date: Nov. 19, 2026

(54) SECURE IDENTITY AND TRUST VERIFICATION SYSTEM WITH REAL-TIME TRUST SCORING AND DISTRIBUTED LEDGER INTEGRATION

(71) Applicant: Ronald Ingram, Henderson, NV (US)

(72) Inventor: Ronald Ingram, Henderson, NV (US)

(21) Appl. No.: 19/677,867

(22) Filed: May 14, 2026

Related U.S. Application Data
(60) Provisional application No. 63/806,552, filed on May 15, 2025.

(51) Int. Cl. G06F 21/32; G06F 21/62

(52) U.S. Cl. CPC G06F 21/32; G06F 21/6227

(57) ABSTRACT

The Secure Identity and Trust Verification System (SITVS) provides real-time identity verification, trust scoring, and threat detection for secure access management. The system integrates distributed ledger technology, multi-modal biometric authentication, public key infrastructure, and neural network-based anomaly detection to deliver tamper-proof, adaptive security. Unlike static credential systems, SITVS dynamically updates trust scores hourly using an algorithm that combines biometric data, social proof, and transactional history. Components include a proprietary trust scoring algorithm, immutable distributed ledger storage, multi-modal biometrics, neural network threat detection, and optional augmented reality and facial action characterization system integrations. The system addresses vulnerabilities in existing identity and access management solutions while ensuring compliance with military-grade security standards. SITVS is designed for defense applications but adaptable to federal agencies, defense contractors, and financial institutions requiring robust identity management.

### CROSS REFERENCE

The present Application for Patent claims the benefit of U.S. Provisional Patent Application No. 63/806,552 by Ingram, entitled “SECURE IDENTITY AND TRUST VERIFICATION SYSTEM WITH REAL-TIME TRUST SCORING AND DISTRIBUTED LEDGER INTEGRATION,” filed May 15, 2025, assigned to the assignee hereof, and is expressly incorporated by reference in its entirety herein.

### FIELD OF TECHNOLOGY

The present disclosure relates to the field of cybersecurity, identity and access management (IAM), and real-time threat detection. Specifically, it pertains to a system and method for secure identity verification and trust assessment using a combination of distributed ledger technology (DLT), multi-modal biometric authentication, public key infrastructure (PKI), neural networks, and real-time trust scoring. Aspects of the disclosure may be implemented in high-security environments, such as military and defense applications, but are also applicable to commercial sectors requiring robust identity management.

### BACKGROUND

Identity and access management (IAM) systems are critical for securing access to sensitive systems, networks, and facilities. Existing IAM solutions, such as the U.S. Department of Defense's Common Access Card (CAC) system, rely on static credentials (e.g., smart cards with PKI certificates) that are vulnerable to identity fraud, insider threats, and social engineering. These systems lack real-time trust assessment, dynamic threat detection, and tamper-proof data storage, leaving gaps in security, particularly in high-stakes military environments. According to the IBM Security Cost of a Data Breach Report 2024, the average cost of a data breach in the U.S. is $9.44 million, with stolen credentials being a primary attack vector. Additionally, insider threats account for significant security incidents, as noted in the 2024 Insider Threat Report by Cybersecurity Insiders.

Commercial IAM solutions offer multifactor authentication (MFA) and cloud-based access control but are not tailored for military-grade requirements, such as operation in contested environments or integration with classified systems. Moreover, these systems do not incorporate distributed ledger technology (DLT) for immutable audit trails or real-time trust scoring to adapt to evolving threats. The need exists for an innovative IAM solution that combines advanced technologies to provide secure, scalable, and dynamic identity verification and threat detection, addressing the limitations of legacy systems like CAC and outperforming commercial alternatives.

### BRIEF DESCRIPTION OF THE DRAWINGS

FIG. 1 illustrates an example of an identity and trust verification system that supports secure identity and trust verification system with real-time trust scoring and distributed ledger integration in accordance with aspects of the present disclosure.

FIG. 2 shows a block diagram of an apparatus that supports secure identity and trust verification system with real-time trust scoring and distributed ledger integration in accordance with aspects of the present disclosure.

FIG. 3 shows a block diagram of an identity manager that supports secure identity and trust verification system with real-time trust scoring and distributed ledger integration in accordance with aspects of the present disclosure.

FIG. 4 shows a diagram of a system including a device that supports secure identity and trust verification system with real-time trust scoring and distributed ledger integration in accordance with aspects of the present disclosure.

FIG. 5 shows a flowchart illustrating methods that support secure identity and trust verification system with real-time trust scoring and distributed ledger integration in accordance with aspects of the present disclosure.

### DETAILED DESCRIPTION

The Secure Identity and Trust Verification System (SITVS) is a cybersecurity solution that provides real-time identity verification, trust scoring, and threat detection for secure access to systems, networks, and facilities. The system integrates an algorithm (USPTO #8,560,436 B2), DLT, PKI, multi-modal biometric authentication, and neural network-based anomaly detection to deliver tamper-proof, scalable, and adaptive security. Unlike static credential systems, SITVS dynamically updates trust scores hourly based on user behavior, biometric data, social proof, and network activity, mitigating risks of identity fraud and insider threats.

Aspects of the present disclosure may include one or more of the following:
Trust Scoring Algorithm: A mathematical model, s(A)=b(n)+(s(B1)+ . . . +s(Bn)), that calculates a user's trust score by combining biometric data (b(n)), social proof (endorsements from trusted entities), and transactional history (s(B1)+ . . . +s(Bn)). The algorithm updates scores hourly, ensuring real-time adaptability to emerging threats.
Distributed Ledger Technology (DLT): Stores identity data and trust scores in an immutable, decentralized ledger, ensuring tamper-proof authentication and auditability compliant with DoD standards (e.g., NIST 800-53).
Multi-Modal Biometric Authentication: Integrates facial, voice, fingerprint, iris, gait, and other biometric modalities for robust identity verification, supporting MFA and continuous authentication.
Neural Network-Based Threat Detection: Employs machine learning to detect anomalies, such as unusual access patterns or behavioral deviations, identifying potential identity fraud or insider threats in real-time.
Public Key Infrastructure (PKI): Secures authentication protocols with cryptographic certificates, ensuring compliance with military-grade encryption standards (e.g., FIPS 140-2).
Augmented Reality (AR) Glasses: Displays real-time trust indicators (e.g., four-color HUD: red for threats, green for verified users) and captures biometric data for identification.
FBI Facial Action Characterization System (FACS): Detects micro-expressions to assess deception, enhancing insider threat detection during interrogations or vetting.

Aspects of the present disclosure address critical pain points in existing IAM systems, including vulnerability to identity fraud ($9.44M per breach), insider threats, and outdated static credentials. It is designed for scalability in large-scale military environments, even in contested settings with limited connectivity, and complies with DoD cybersecurity standards (e.g., NIST 800-53, DFARS 252.204-7012). The system's modular architecture supports integration with existing infrastructure, such as CAC systems, and offers commercial applications in federal agencies, defense contractors, and financial institutions.

Aspects of the disclosure are initially described in the context of an environment deploying secure identity verification. Aspects of the disclosure are further described with respect to a process flow. Aspects of the disclosure are further illustrated by and described with reference to apparatus diagrams, system diagrams, and flowcharts that relate to secure identity and trust verification system with real-time trust scoring and distributed ledger integration.

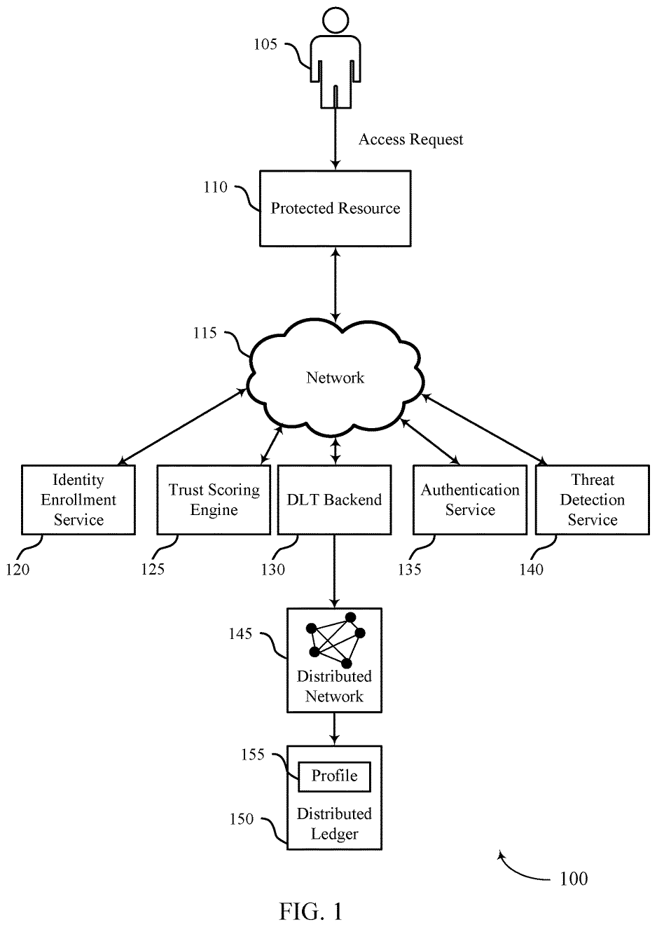

FIG. 1 illustrates an example of a system 100 that supports secure identity and trust verification system with real-time trust scoring and distributed ledger integration in accordance with various aspects of the present disclosure. Various aspects of the system 100 may communicate via one or more networks (e.g., a network 115). The system 100 includes an Identity Enrollment service 120 which:
Captures multi-modal biometric data (facial, voice, fingerprint, iris, gait) using high-resolution sensors.
Generates a unique user profile stored on a DLT, secured by PKI certificates.
Incorporates social proof (e.g., endorsements from trusted entities) to initialize the trust score.

The system 100 includes a Trust Scoring Engine 125 which:
Implements the algorithm s(A)=b(n)+(s(B1)+ . . . +s(Bn)), where:
   s(A) is the user's trust score.
   b(n) represents biometric validation scores (e.g., facial recognition confidence).
   s(B1)+ . . . +s(Bn) aggregates social proof and transactional history (e.g., successful access attempts, endorsements).
Updates trust scores hourly based on inputs from biometric sensors, network activity, and behavioral data.
Uses neural networks to weight inputs dynamically, adapting to evolving threat patterns.

The system 100 includes a DLT Backend 130, which:
Stores user profiles, trust scores, and access logs in a decentralized, tamper-proof ledger (e.g., the distributed ledger 150 that is supported by a distributed network 145).
Supports low-latency performance in austere environments through optimized consensus mechanisms (e.g., practical Byzantine fault tolerance).
Ensures auditability and compliance with DoD standards (e.g., NIST 800-53).

The system 100 includes an Authentication Service 135, which:
Combines PKI and biometric MFA for secure access to systems, networks, or facilities.
Validates user identity against DLT-stored profiles, rejecting unauthorized access attempts.
Supports continuous authentication by monitoring biometric and behavioral data during sessions.

The system 100 includes a Threat Detection Service 140, which:
Uses neural networks and pattern recognition to identify anomalies, such as:
   Unusual access patterns (e.g., logins from unfamiliar locations).
   Behavioral deviations (e.g., changes in typing speed or voice patterns).
   Potential deception indicators (via optional FACS integration).
Generates real-time alerts for operators or command systems.

The system 100 may include:
AR Glasses Interface, which:
   Displays a four-color HUD (red: threat, green: friendly, amber: neutral, grey: unknown) based on trust scores.
   Captures biometric data (e.g., facial, iris) for real-time identification.
   Supports tagging and tracking of individuals in dynamic environments.
FACS Integration, which:
   Analyzes micro-expressions using AI and high-resolution cameras to detect deception.
   Outputs alerts (e.g., “Deception Detected”) to HUD or command systems.
   Combines FACS data with trust scores for refined threat assessments.

In accordance with techniques described herein, a user 105 may enroll with the system 100 via using the identity enrollment service 120. For example, during a user enrollment procedure, a user (e.g., soldier, contractor) enrolls by providing biometric data (facial, voice, fingerprint) and social proof (e.g., endorsements from a commanding officer). The system 100 generates a PKI-secured profile (e.g., profile 155), which is stored on the DLT (e.g., the distributed ledger 150), and the system 100 (e.g., the trust scoring engine 125) initializes a trust score using the algorithm s(A)=b(n)+(s(B1)+ . . . +s(Bn)). The initialized trust score may be stored in association with the profile on the distributed ledger.

The user 105 may attempt to access a protected resource 110, which may be an example of system, facility, or other secured environment or resource. The user may access a panel, sensor, computer, etc. that includes one or more sensors for requesting access to the protected resource 110. Via the sensor(s), the user may provide biometric credentials, such as a facial scan, fingerprint, voice sample, etc. and social proof (e.g., endorsements from a commanding officer). The authentication service 135 may validate the received credentials against the credentials stored in the profile 155 obtained from the distributed ledger 150 (e.g., based on communications with the DLT backend 130). Public key infrastructure (PKI) may be used to ensure security. For example, the profile 155 or portions thereof may be encrypted using a public key before the profile 155 is stored via DLT. A decryption key may be used by the authenticated service 135 for decrypting the profile and validating the credentials against the profile 155. The trust scoring engine 125 may recalculate the user's trust score based on current biometric data, recent behavior, network activity, etc. Based on the validation, an action may be triggered. For example, if the credentials are validated, then the user 105 may be provided access to the protected resource 110. If the credentials are not validated, an alert may be triggered and/or access may be denied.

The threat detection service 140 may monitor for anomalies (e.g., multiple failed login attempts, unusual access times, etc.). If an anomaly is detected, then the system 100 may lower the trust score and may trigger alerts and/or deny access. Optional FACS integration may analyze micro-expressions during high-stakes interactions (e.g., interrogations) and flag potential deception.

In some cases, the system 100 includes AR glasses feedback. In such cases, operators or users wearing AR glasses may view a HUD displaying the user's trust status (e.g., green for verified, red for threat). The AR glasses may capture additional biometric data to refine trust scores in real-time.

The system 100 may also implement audit and compliance mechanisms. For example, access attempts and trust score updates are logged on the DLT, creating an immutable audit trail. The system 100 may also conduct periodic bias audits to ensure equitable scoring, complying with Diversity, Equity, and Inclusion (DEI) standards.

Thus, the techniques described herein support the following features:
Dynamic Trust Scoring:
   Unlike static credential systems (e.g., CAC), SITVS updates trust scores hourly using an algorithm, integrating biometric, behavioral, and social proof data.
   The algorithm's exponential difficulty in falsification (due to DLT and PKI) ensures robust security.
DLT-PKI Integration:
   Combines DLT's immutability with PKI's cryptographic security, creating a tamper-proof IAM system optimized for military environments.
Multi-Modal Biometrics:
   Integrates multiple biometric modalities (facial, voice, fingerprint, iris, gait) for continuous authentication, surpassing single-modality systems in accuracy and resilience.
Real-time Threat Detection:
   Uses neural networks to detect anomalies and insider threats in real-time, addressing gaps in commercial IAM solutions.
AR and FACS Modularity:
   Optional AR glasses and FACS integration provide situational awareness and deception detection, tailored for high-stakes military scenarios (e.g., checkpoints, interrogations).

### Advantages Over Prior Art

Compared to CAC Systems:
   CAC relies on static PKI certificates, vulnerable to theft or misuse. SITVS offers dynamic trust scoring and biometric authentication, reducing fraud risks.
   CAC lacks real-time threat detection, while SITVS uses neural networks to identify anomalies instantly.
Compared to Commercial IAM:
   Commercial solutions lack DLT for tamper-proof storage and are not designed for contested military environments. SITVS ensures low-latency performance in austere settings.
   SITVS's algorithm and modular integrations (AR, FACS) provide military-specific features absent in commercial systems.
Compared to Existing DLT-Based IAM:
   While some DLT-based IAM systems exist, they do not integrate real-time trust scoring, multi-modal biometrics, and neural network threat detection in a single platform optimized for DoD compliance.

The system 100 may provide one or more of the following advantages:
Compared to CAC Systems:
   CAC relies on static PKI certificates, vulnerable to theft or misuse. SITVS offers dynamic trust scoring and biometric authentication, reducing fraud risks.
   CAC lacks real-time threat detection, while SITVS uses neural networks to identify anomalies instantly.
Compared to Commercial IAM:
   Commercial solutions lack DLT for tamper-proof storage and are not designed for contested military environments. SITVS ensures low-latency performance in austere settings.
   SITVS's algorithm and modular integrations (AR, FACS) provide military-specific features absent in commercial systems.
Compared to Existing DLT-based IAM:
   While some DLT-based IAM systems exist, they do not integrate real-time trust scoring, multi-modal biometrics, and neural network threat detection in a single platform optimized for DoD compliance.

The system 100 may be applied in the following scenarios or environments:
Military and Defense:
   Secure access to DoD systems, networks, and facilities (e.g., Army bases, command centers).
   Real-time threat detection at checkpoints or forward operating bases using AR glasses.
   Insider threat mitigation during contractor vetting or interrogations with FACS.
Federal Agencies:
   Identity management for DHS, VA, or other agencies requiring FedRAMP-compliant solutions.
Commercial Sectors:
   Defense contractors needing DoD-compliant IAM.
   Financial institutions requiring robust authentication to prevent fraud.
   Law enforcement agencies leveraging AR and FACS for security operations.

The system 100 may include one or more various implementations as follows:
First Implementation:
   A standalone SITVS deployed on DoD servers, integrating DLT, PKI, biometrics, and neural networks for secure IAM and threat detection.
   Used at Army bases for access control and insider threat monitoring.
AR-Enhanced Implementation:
   SITVS with AR glasses for operators at checkpoints, displaying real-time trust indicators and capturing biometric data.
   Deployed in dynamic environments (e.g., forward operating bases).
FACS-Enhanced Implementation:
   SITVS with FACS integration for interrogation or vetting scenarios, detecting deception via micro-expressions.
   Used by Army intelligence units or contractor vetting teams.
Cloud-Based Implementation:
   A FedRAMP-compliant SITVS deployed on AWS or similar platforms for federal agencies or commercial clients.
   Supports SaaS subscriptions for scalable IAM.

The system 100 may include the following aspects:
Hardware:
   Biometric sensors (e.g., facial recognition cameras, fingerprint scanners, voice recorders).
   AR glasses with HUD displays and high-resolution cameras.
   DLT nodes (e.g., servers running Hyperledger Fabric or equivalent).
   Edge devices for low-latency processing in austere environments.
Software:
   Trust scoring algorithm implemented in Python or Rust.
   Neural networks trained on TensorFlow or PyTorch for threat detection.
   DLT platform with optimized consensus for low-latency performance.
   API for integration with existing DoD systems (e.g., CAC infrastructure).
Compliance:
   Adheres to NIST 800-53, DFARS 252.204-7012, and FIPS 140-2.
   Conducts bias audits for DEI-compliant scoring.

The Secure Identity and Trust Verification System (SITVS) represents a transformative advancement in IAM, combining a trust scoring algorithm, DLT, PKI, multi-modal biometrics, and neural networks to deliver secure, scalable, and real-time identity verification and threat detection. Its modular architecture, with optional AR and FACS integrations, addresses critical cybersecurity challenges in military and commercial applications, offering significant advantages over prior art. The system is poised for operational deployment in DoD environments and has substantial commercial potential in federal and private sectors.

The various systems and components described herein may utilize AI technologies. The described AI technologies encompass a range of capabilities, including classification, prediction, generation, and conversation, using various forms of machine learning and neural networks. Incorporated into hardware or software frameworks, these AI models can perform functions like retrieval, generation, and transmission, supported by processors or CPUs. The AI can be trained using supervised, unsupervised, or other techniques on general or specialized datasets and may be updated periodically or in real-time. It offers diverse functionalities such as text, audio, and image generation, translation, summarization, classification, prediction, recommendation, and more, often responding to specific prompts. Advanced techniques like Retrieval-Augmented Generation (RAG) allow AI to access external knowledge bases post-training to refine outputs. AI models can work sequentially or in parallel, with outputs from one serving as inputs to another, and can be combined using methods like bagging, boosting, or stacking to enhance performance.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

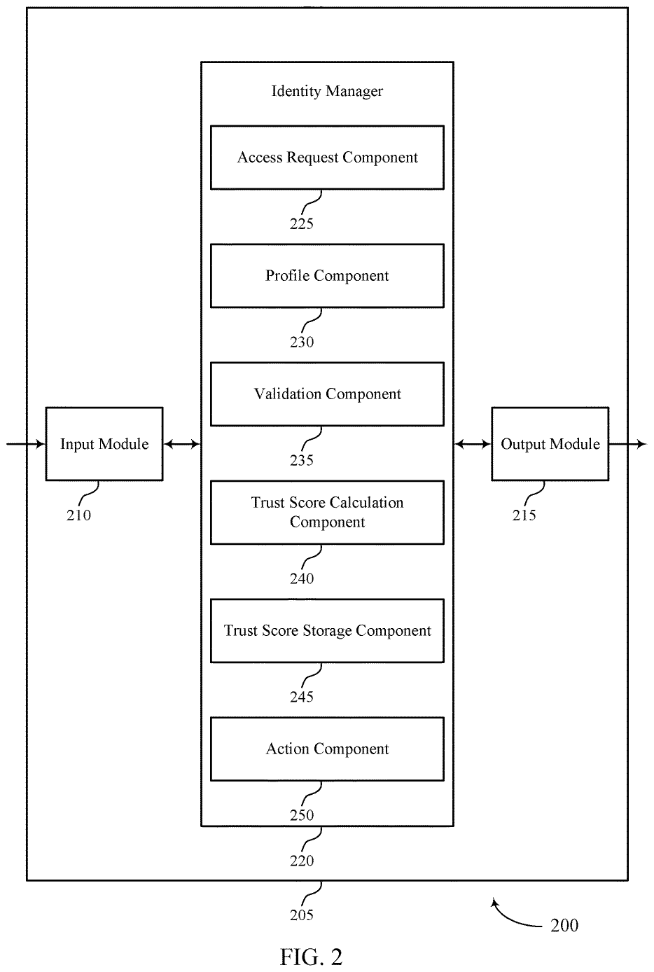

FIG. 2 shows a block diagram 200 of a device 205 that supports secure identity and trust verification system with real-time trust scoring and distributed ledger integration in accordance with aspects of the present disclosure. The device 205 may include an input module 210, an output module 215, and an identity manager 220. The device 205, or one or more components of the device 205 (e.g., the input module 210, the output module 215, the identity manager 220), may include at least one processor, which may be coupled with at least one memory, to support the described techniques. Each of these components may be in communication with one another (e.g., via one or more buses).

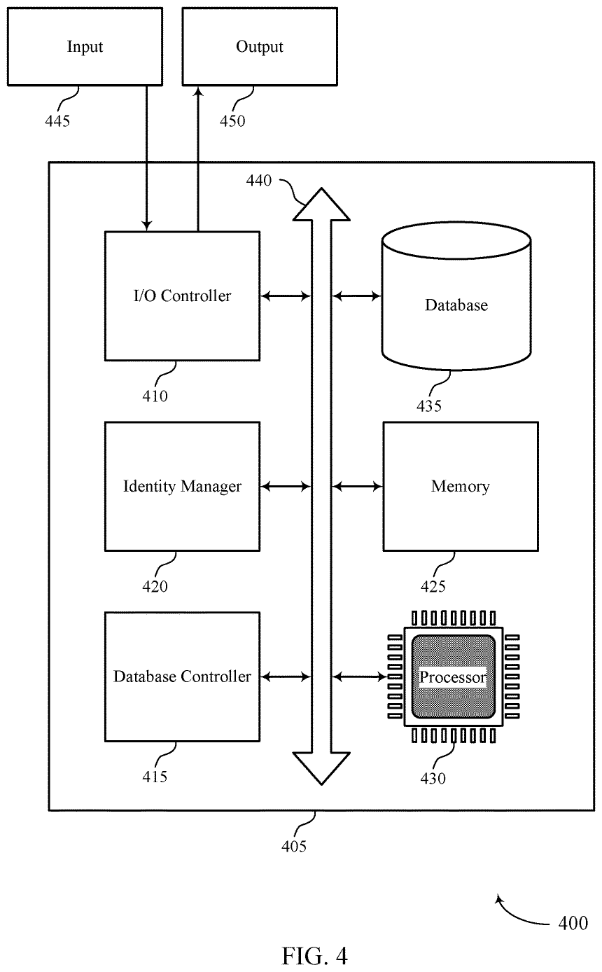

The input module 210 may manage input signals for the device 205. For example, the input module 210 may identify input signals based on an interaction with a modem, a keyboard, a mouse, a touchscreen, or a similar device. These input signals may be associated with user input or processing at other components or devices. In some cases, the input module 210 may utilize an operating system such as iOS®, ANDROID®, MS-DOS®, MS-WINDOWS®, OS/2®, UNIX®, LINUX®, or another known operating system to handle input signals. The input module 210 may send aspects of these input signals to other components of the device 205 for processing. For example, the input module 210 may transmit input signals to the identity manager 220 to support secure identity and trust verification system with real-time trust scoring and distributed ledger integration. In some cases, the input module 210 may be a component of an input/output (I/O) controller 410 as described with reference to FIG. 4.

The output module 215 may manage output signals for the device 205. For example, the output module 215 may receive signals from other components of the device 205, such as the identity manager 220, and may transmit these signals to other components or devices. In some examples, the output module 215 may transmit output signals for display in a user interface, for storage in a database or data store, for further processing at a server or server cluster, or for any other processes at any number of devices or systems. In some cases, the output module 215 may be a component of an I/O controller 410 as described with reference to FIG. 4.

For example, the identity manager 220 may include an access request component 225, a profile component 230, a validation component 235, a trust score calculation component 240, a trust score storage component 245, an action component 250, or any combination thereof. In some examples, the identity manager 220, or various components thereof, may be configured to perform various operations (e.g., receiving, monitoring, transmitting) using or otherwise in cooperation with the input module 210, the output module 215, or both. For example, the identity manager 220 may receive information from the input module 210, send information to the output module 215, or be integrated in combination with the input module 210, the output module 215, or both to receive information, transmit information, or perform various other operations as described herein.

The access request component 225 may be configured to support receiving a request to access a protected resource by a user, the request including one or more biometric credentials. The profile component 230 may be configured to support obtaining, from a distributed ledger data store, a profile associated with the user. The validation component 235 may be configured to support validating the one or more biometric credentials using the profile associated with the user. The trust score calculation component 240 may be configured to support calculating an updated trust score associated with the user based on the one or more biometric credentials, user behavior, network activity, or a combination thereof. The trust score storage component 245 may be configured to support storing the updated trust score in association with the profile at the distributed ledger data store. The action component 250 may be configured to support triggering an action associated with the request to access the protected resource by the user.

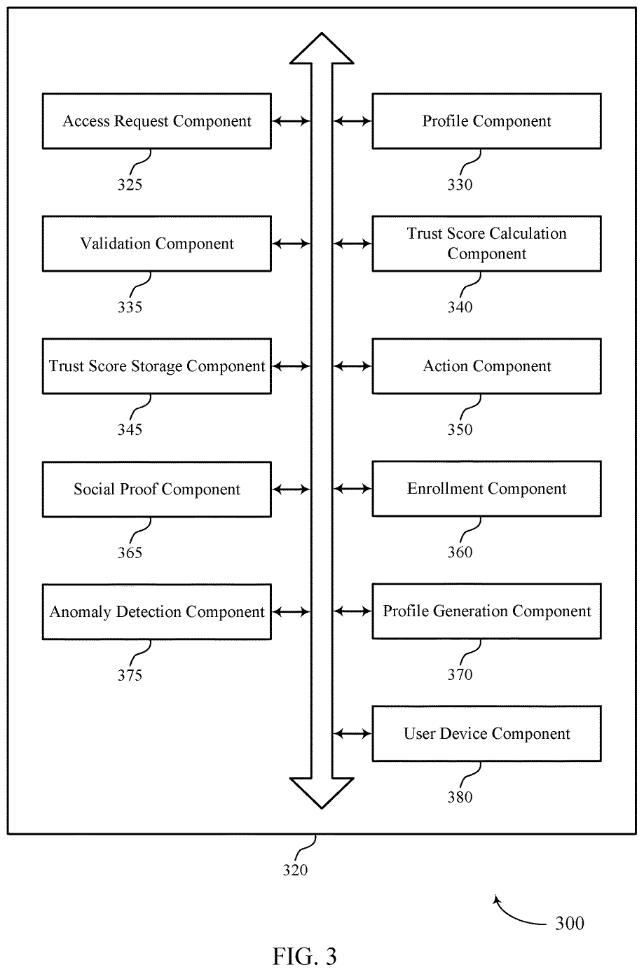

FIG. 3 shows a block diagram 300 of an identity manager 320 that supports secure identity and trust verification system with real-time trust scoring and distributed ledger integration in accordance with aspects of the present disclosure. The identity manager 320 may be an example of aspects of an identity manager or an identity manager 220, or both, as described herein. The identity manager 320, or various components thereof, may be an example of means for performing (e.g., to cause the identity manager 320 to perform) various aspects of secure identity and trust verification system with real-time trust scoring and distributed ledger integration as described herein. For example, the identity manager 320 may include an access request component 325, a profile component 330, a validation component 335, a trust score calculation component 340, a trust score storage component 345, an action component 350, an enrollment component 360, a social proof component 365, a profile generation component 370, an anomaly detection component 375, a user device component 380, or any combination thereof. Each of these components, or components of subcomponents thereof (e.g., one or more processors, one or more memories), may communicate, directly or indirectly, with one another (e.g., via one or more buses).

The access request component 325 may be configured to support receiving a request to access a protected resource by a user, the request including one or more biometric credentials. The profile component 330 may be configured to support obtaining, from a distributed ledger data store, a profile associated with the user. The validation component 335 may be configured to support validating the one or more biometric credentials using the profile associated with the user. The trust score calculation component 340 may be configured to support calculating an updated trust score associated with the user based on the one or more biometric credentials, user behavior, network activity, or a combination thereof. The trust score storage component 345 may be configured to support storing the updated trust score in association with the profile at the distributed ledger data store. The action component 350 may be configured to support triggering an action associated with the request to access the protected resource by the user.

In some examples, the one or more biometric credentials include a facial scan, a voice sample, a fingerprint, iris scan, gait scan, or a combination thereof.

In some examples, the enrollment component 360 may be configured to support receiving, from the user, an enrollment request associated with the protected resource, the enrollment request including one or more initial biometric credentials. In some examples, the social proof component 365 may be configured to support receiving a social proof associated with the enrollment request by an authenticated user. In some examples, the profile generation component 370 may be configured to support generating the profile associated with the user based on the one or more initial biometric credentials and the social proof. In some examples, the trust score storage component 345 may be configured to support storing the generated profile on the distributed ledger data store, the user profile secured using a public key encryption scheme.

In some examples, the anomaly detection component 375 may be configured to support detecting an anomaly associated with the request to access the protected resource, where calculating the updated trust score includes lowering the trust score in accordance with detecting the anomaly.

In some examples, the user device component 380 may be configured to support displaying via a user device associated with a second user in proximity to the user, an indication of the updated trust score.

FIG. 4 shows a diagram of a system 400 including a device 405 that supports secure identity and trust verification system with real-time trust scoring and distributed ledger integration in accordance with aspects of the present disclosure. The device 405 may be an example of or include components of a device 205 as described herein. The device 405 may include components for bi-directional data communications including components for transmitting and receiving communications, such as an identity manager 420, an I/O controller, such as an I/O controller 410, a database controller 415, at least one memory 425, at least one processor 430, and a database 435. These components may be in electronic communication or otherwise coupled (e.g., operatively, communicatively, functionally, electronically, electrically) via one or more buses (e.g., a bus 440).

The I/O controller 410 may manage input signals 445 and output signals 450 for the device 405. The I/O controller 410 may also manage peripherals not integrated into the device 405. In some cases, the I/O controller 410 may represent a physical connection or port to an external peripheral. In some cases, the I/O controller 410 may utilize an operating system such as iOS®, ANDROID®, MS-DOS®, MS-WINDOWS®, OS/2®, UNIX®, LINUX®, or another known operating system. In other cases, the I/O controller 410 may represent or interact with a modem, a keyboard, a mouse, a touchscreen, or a similar device. In some cases, the I/O controller 410 may be implemented as part of a processor 430. In some examples, a user may interact with the device 405 via the I/O controller 410 or via hardware components controlled by the I/O controller 410.

The database controller 415 may manage data storage and processing in a database 435. In some cases, a user may interact with the database controller 415. In other cases, the database controller 415 may operate automatically without user interaction. The database 435 may be an example of a single database, a distributed database, multiple distributed databases, a data store, a data lake, or an emergency backup database.

Memory 425 may include random-access memory (RAM) and read-only memory (ROM). The memory 425 may store computer-readable, computer-executable software including instructions that, when executed, cause at least one processor 430 to perform various functions described herein. In some cases, the memory 425 may contain, among other things, a basic I/O system (BIOS) which may control basic hardware or software operation such as the interaction with peripheral components or devices. The memory 425 may be an example of a single memory or multiple memories. For example, the device 405 may include one or more memories 425.

The processor 430 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 430 may be configured to operate a memory array using a memory controller. In other cases, a memory controller may be integrated into the processor 430. The processor 430 may be configured to execute computer-readable instructions stored in at least one memory 425 to perform various functions (e.g., functions or tasks supporting secure identity and trust verification system with real-time trust scoring and distributed ledger integration). The processor 430 may be an example of a single processor or multiple processors. For example, the device 405 may include one or more processors 430.

For example, the identity manager 420 may be configured to support receiving a request to access a protected resource by a user, the request including one or more biometric credentials. The identity manager 420 may be configured to support obtaining, from a distributed ledger data store, a profile associated with the user. The identity manager 420 may be configured to support validating the one or more biometric credentials using the profile associated with the user. The identity manager 420 may be configured to support calculating an updated trust score associated with the user based on the one or more biometric credentials, user behavior, network activity, or a combination thereof. The identity manager 420 may be configured to support storing the updated trust score in association with the profile at the distributed ledger data store. The identity manager 420 may be configured to support triggering an action associated with the request to access the protected resource by the user.

By including or configuring the identity manager 420 in accordance with examples as described herein, the device 405 may support techniques for more efficient and real-time identity verification for user access to a secure resource.

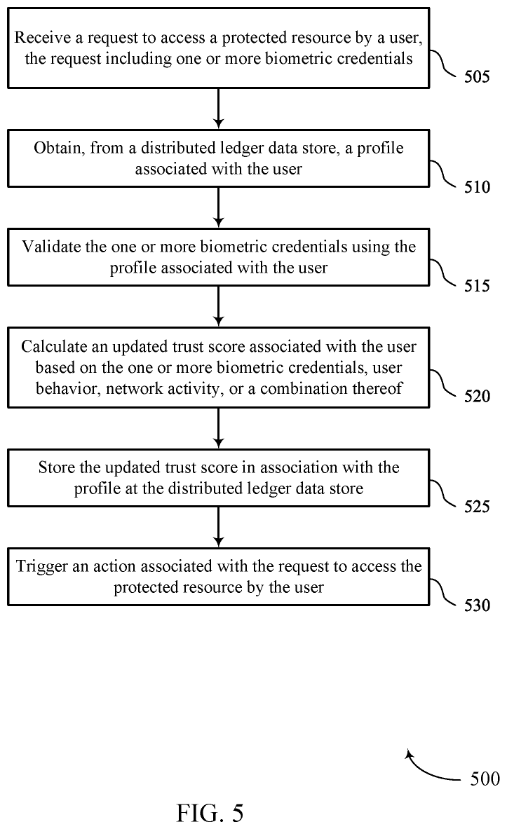

FIG. 5 shows a flowchart illustrating a method 500 that supports secure identity and trust verification system with real-time trust scoring and distributed ledger integration in accordance with aspects of the present disclosure. The operations of the method 500 may be implemented by an identity system or its components as described herein. For example, the operations of the method 500 may be performed by an identity system as described with reference to FIGS. 1 through 4. In some examples, an identity system may execute a set of instructions to control the functional elements of the identity system to perform the described functions. Additionally, or alternatively, the identity system may perform aspects of the described functions using special-purpose hardware.

At 505, the method may include receiving a request to access a protected resource by a user, the request including one or more biometric credentials. The operations of 505 may be performed in accordance with examples as disclosed herein. In some examples, aspects of the operations of 505 may be performed by an access request component 325.

At 510, the method may include obtaining, from a distributed ledger data store, a profile associated with the user. The operations of 510 may be performed in accordance with examples as disclosed herein. In some examples, aspects of the operations of 510 may be performed by a profile component 330.

At 515, the method may include validating the one or more biometric credentials using the profile associated with the user. The operations of 515 may be performed in accordance with examples as disclosed herein. In some examples, aspects of the operations of 515 may be performed by a validation component 335.

At 520, the method may include calculating an updated trust score associated with the user based on the one or more biometric credentials, user behavior, network activity, or a combination thereof. The operations of 520 may be performed in accordance with examples as disclosed herein. In some examples, aspects of the operations of 520 may be performed by a trust score calculation component 340.

At 525, the method may include storing the updated trust score in association with the profile at the distributed ledger data store. The operations of 525 may be performed in accordance with examples as disclosed herein. In some examples, aspects of the operations of 525 may be performed by a trust score storage component 345.

At 530, the method may include triggering an action associated with the request to access the protected resource by the user. The operations of 530 may be performed in accordance with examples as disclosed herein. In some examples, aspects of the operations of 530 may be performed by an action component 350.

A method by an apparatus is described. The method may include receiving a request to access a protected resource by a user, the request including one or more biometric credentials, obtaining, from a distributed ledger data store, a profile associated with the user, validating the one or more biometric credentials using the profile associated with the user, calculating an updated trust score associated with the user based on the one or more biometric credentials, user behavior, network activity, or a combination thereof, storing the updated trust score in association with the profile at the distributed ledger data store, and triggering an action associated with the request to access the protected resource by the user.

An apparatus is described. The apparatus may include one or more memories storing processor executable code, and one or more processors coupled with the one or more memories. The one or more processors may individually or collectively be operable to execute the code to cause the apparatus to receive a request to access a protected resource by a user, the request including one or more biometric credentials, obtain, from a distributed ledger data store, a profile associated with the user, validate the one or more biometric credentials using the profile associated with the user, calculate an updated trust score associated with the user based on the one or more biometric credentials, user behavior, network activity, or a combination thereof, store the updated trust score in association with the profile at the distributed ledger data store, and trigger an action associated with the request to access the protected resource by the user.

Another apparatus is described. The apparatus may include means for receiving a request to access a protected resource by a user, the request including one or more biometric credentials, means for obtaining, from a distributed ledger data store, a profile associated with the user, means for validating the one or more biometric credentials using the profile associated with the user, means for calculating an updated trust score associated with the user based on the one or more biometric credentials, user behavior, network activity, or a combination thereof, means for storing the updated trust score in association with the profile at the distributed ledger data store, and means for triggering an action associated with the request to access the protected resource by the user.

A non-transitory computer-readable medium storing code is described. The code may include instructions executable by one or more processors to receive a request to access a protected resource by a user, the request including one or more biometric credentials, obtain, from a distributed ledger data store, a profile associated with the user, validate the one or more biometric credentials using the profile associated with the user, calculate an updated trust score associated with the user based on the one or more biometric credentials, user behavior, network activity, or a combination thereof, store the updated trust score in association with the profile at the distributed ledger data store, and trigger an action associated with the request to access the protected resource by the user.

In some examples of the method, apparatus, and non-transitory computer-readable medium described herein, the one or more biometric credentials include a facial scan, a voice sample, a fingerprint, iris scan, gait scan, or a combination thereof.

Some examples of the method, apparatus, and non-transitory computer-readable medium described herein may further include operations, features, means, or instructions for receiving, from the user, an enrollment request associated with the protected resource, the enrollment request including one or more initial biometric credentials, receiving a social proof associated with the enrollment request by an authenticated user, generating the profile associated with the user based on the one or more initial biometric credentials and the social proof, and storing the generated profile on the distributed ledger data store, the profile secured using a public key encryption scheme.

Some examples of the method, apparatus, and non-transitory computer-readable medium described herein may further include operations, features, means, or instructions for detecting an anomaly associated with the request to access the protected resource, where calculating the updated trust score includes lowering the trust score in accordance with detecting the anomaly.

Some examples of the method, apparatus, and non-transitory computer-readable medium described herein may further include operations, features, means, or instructions for displaying via a user device associated with a second user in proximity to the user, an indication of the updated trust score.

The following provides an overview of aspects of the present disclosure:

Aspect 1: A method, comprising: receiving a request to access a protected resource by a user, the request comprising one or more biometric credentials; obtaining, from a distributed ledger data store, a profile associated with the user; validating the one or more biometric credentials using the profile associated with the user; calculating an updated trust score associated with the user based at least in part on the one or more biometric credentials, user behavior, network activity, or a combination thereof; storing the updated trust score in association with the profile at the distributed ledger data store; and triggering an action associated with the request to access the protected resource by the user.

Aspect 2: The method of aspect 1, wherein the one or more biometric credentials comprise a facial scan, a voice sample, a fingerprint, iris scan, gait scan, or a combination thereof.

Aspect 3: The method of any of aspects 1 through 2, further comprising: receiving, from the user, an enrollment request associated with the protected resource, the enrollment request comprising one or more initial biometric credentials; receiving a social proof associated with the enrollment request by an authenticated user; generating the profile associated with the user based at least in part on the one or more initial biometric credentials and the social proof; storing the generated profile on the distributed ledger data store, the profile secured using a public key encryption scheme.

Aspect 4: The method of any of aspects 1 through 3, further comprising: detecting an anomaly associated with the request to access the protected resource, wherein calculating the updated trust score comprises lowering the trust score in accordance with detecting the anomaly.

Aspect 5: The method of any of aspects 1 through 4, further comprising: displaying via a user device associated with a second user in proximity to the user, an indication of the updated trust score.

Aspect 6: An apparatus comprising one or more memories storing processor-executable code, and one or more processors coupled with the one or more memories and individually or collectively operable to execute the code to cause the apparatus to perform a method of any of aspects 1 through 5.

Aspect 7: An apparatus comprising at least one means for performing a method of any of aspects 1 through 5.

Aspect 8: A non-transitory computer-readable medium storing code the code comprising instructions executable by one or more processors to perform a method of any of aspects 1 through 5.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving a request to access a protected resource by a user, the request comprising one or more biometric credentials;
obtaining, from a distributed ledger data store, a profile associated with the user;
validating the one or more biometric credentials using the profile associated with the user;
calculating an updated trust score associated with the user based at least in part on the one or more biometric credentials, user behavior, network activity, or a combination thereof;
storing the updated trust score in association with the profile at the distributed ledger data store; and
triggering an action associated with the request to access the protected resource by the user.

2. The method of claim 1, wherein the one or more biometric credentials comprise a facial scan, a voice sample, a fingerprint, iris scan, gait scan, or a combination thereof.

3. The method of claim 1, further comprising:
receiving, from the user, an enrollment request associated with the protected resource, the enrollment request comprising one or more initial biometric credentials;
receiving a social proof associated with the enrollment request by an authenticated user;
generating the profile associated with the user based at least in part on the one or more initial biometric credentials and the social proof;
storing the generated profile on the distributed ledger data store, the profile secured using a public key encryption scheme.

4. The method of claim 1, further comprising:
detecting an anomaly associated with the request to access the protected resource, wherein calculating the updated trust score comprises lowering the trust score in accordance with detecting the anomaly.

5. The method of claim 1, further comprising:
displaying via a user device associated with a second user in proximity to the user, an indication of the updated trust score.

6. An apparatus, comprising:
one or more memories storing processor-executable code; and
one or more processors coupled with the one or more memories and individually or collectively operable to execute the code to cause the apparatus to:
receive a request to access a protected resource by a user, the request comprising one or more biometric credentials;
obtain, from a distributed ledger data store, a profile associated with the user;
validate the one or more biometric credentials using the profile associated with the user;
calculate an updated trust score associated with the user based at least in part on the one or more biometric credentials, user behavior, network activity, or a combination thereof;
store the updated trust score in association with the profile at the distributed ledger data store; and
trigger an action associated with the request to access the protected resource by the user.

7. The apparatus of claim 6, wherein the one or more biometric credentials comprise a facial scan, a voice sample, a fingerprint, iris scan, gait scan, or a combination thereof.

8. The apparatus of claim 6, wherein the one or more processors are individually or collectively further operable to execute the code to cause the apparatus to:
receive, from the user, an enrollment request associated with the protected resource, the enrollment request comprising one or more initial biometric credentials;
receive a social proof associated with the enrollment request by an authenticated user;
generate the profile associated with the user based at least in part on the one or more initial biometric credentials and the social proof;
store the generated profile on the distributed ledger data store, the profile secured using a public key encryption scheme.

9. The apparatus of claim 6, wherein the one or more processors are individually or collectively further operable to execute the code to cause the apparatus to:
detect an anomaly associated with the request to access the protected resource, wherein calculating the updated trust score comprises lowering the trust score in accordance with detecting the anomaly.

10. The apparatus of claim 6, wherein the one or more processors are individually or collectively further operable to execute the code to cause the apparatus to:
display via a user device associated with a second user in proximity to the user, an indication of the updated trust score.

11. A non-transitory computer-readable medium storing code, the code comprising instructions executable by one or more processors to:
receive a request to access a protected resource by a user, the request comprising one or more biometric credentials;
obtain, from a distributed ledger data store, a profile associated with the user;
validate the one or more biometric credentials using the profile associated with the user;
calculate an updated trust score associated with the user based at least in part on the one or more biometric credentials, user behavior, network activity, or a combination thereof;
store the updated trust score in association with the profile at the distributed ledger data store; and
trigger an action associated with the request to access the protected resource by the user.

12. The non-transitory computer-readable medium of claim 11, wherein the one or more biometric credentials comprise a facial scan, a voice sample, a fingerprint, iris scan, gait scan, or a combination thereof.

13. The non-transitory computer-readable medium of claim 11, wherein the instructions are further executable by the one or more processors to:
receive, from the user, an enrollment request associated with the protected resource, the enrollment request comprising one or more initial biometric credentials;
receive a social proof associated with the enrollment request by an authenticated user;
generate the profile associated with the user based at least in part on the one or more initial biometric credentials and the social proof;
store the generated profile on the distributed ledger data store, the profile secured using a public key encryption scheme.

14. The non-transitory computer-readable medium of claim 11, wherein the instructions are further executable by the one or more processors to:
detect an anomaly associated with the request to access the protected resource, wherein calculating the updated trust score comprises lowering the trust score in accordance with detecting the anomaly.

15. The non-transitory computer-readable medium of claim 11, wherein the instructions are further executable by the one or more processors to:
display via a user device associated with a second user in proximity to the user, an indication of the updated trust score.
